(19) United States
(12) Patent Application Publication
(10) Pub. No.: US 2023/0037432 A1
(43) Pub. Date: Feb. 9, 2023

(54) CLASSIFICATION METHOD, CLASSIFICATION DEVICE, AND CLASSIFICATION PROGRAM

(71) Applicant: NIPPON TELEGRAPH AND TELEPHONE CORPORATION, Tokyo (JP)

(72) Inventors: Tokuma TOMOE, Musashino-shi, Tokyo (JP); Junya ARAI, Musashino-shi, Tokyo (JP); Keitaro HORIKAWA, Musashino-shi, Tokyo (JP)

(73) Assignee: NIPPON TELEGRAPH AND TELEPHONE CORPORATION, Tokyo (US)

(21) Appl. No.: 17/793,413

(22) PCT Filed: Feb. 14, 2020
(86) PCT No.: PCT/JP2020/005909

§ 371 Date: Jul. 18, 2022

(51) Int. Cl. G06N 20/10; G06F 16/906

(52) U.S. Cl. CPC G06N 20/10; G06F 16/906

(57) ABSTRACT

A classification unit causes each of a plurality of classifiers trained to classify data of a corresponding class into one of two values through qSVM to classify data for prediction. Further, the calculation unit calculates the energy of the classification result of the data for prediction for each of the plurality of classifiers. Further, the determination unit determines a class of the data for prediction based on the classification result of the classification unit and the energy calculated by the calculation unit.

### TECHNICAL FIELD

The present invention relates to a classification method, a classification apparatus, and a classification program.

### BACKGROUND ART

Support Vector Machines (SVM) are known as a classification scheme for pattern recognition using supervised machine learning. In SVM, data is linearly separated through margin maximization. For example, SVM may be used for determination of spam mails, medical image diagnosis, voice recognition, credit evaluation, and the like.

Further, a scheme of transforming data that cannot be linearly separated, through a kernel trick, and applying an SVM is known. Further, a scheme of optimizing an SVM using a kernel trick into a quantum annealing machine or an Ising machine to improve generalization performance is known (see, for example, NPL 2). Hereinafter, an SVM optimized into a quantum annealing machine or an Ising machine is referred to as an Ising model-based SVM.

### CITATION LIST

### Non Patent Literature

[NPL 1] Andrew Lucas, “Ising formations of many NP problems”, Frontiers in Physics 2, 5 (2014) (URL: https://arxiv.org/abs/1302.5843v3)
[NPL 2] Dennis Willsch, Madita Willsch, Hans De Raedt, Kristel Michielsen, “Support vector machines on the D-Wave quantum annealer” (URL: https://arxiv.org/abs/1906.06283)
[NPL 3] Christopher M. Bishop, “Pattern Recognition and Machine Learning”, pp 338-339, Information Science and Statistics (URL: http://users.isr.ist.utl.ptt-wurmd/Livros/school/Bishop-Pattern Recognition And Machine Learning-Springer 2006.pdf)
[NPL 4] William H. Press, Saul A. Teukolsky, William T. Vetterling, Brian P. Flannery, “NUMERICAL RECIPES The Art of Scientific Computing Third Edition”, pp 883-892, CAMBRIDGE UNIVERSITY PRESS (URL:https://e-maxx.ru/bookz/files/numerical_recipes.pdf)

### SUMMARY OF THE INVENTION

### Technical Problem

However, the Ising model-based SVM has a problem that it may be difficult to perform multi-value classification of data therewith. Because the SVM performs binary classification through linear separation, it is difficult to apply the SVM to multi-value classification.

### Means for Solving the Problem

In order to solve the above-described problem and achieve the object, a classification method is a classification method at a classification apparatus, the classification method including: causing each of a plurality of classifiers trained to classify data of a corresponding class into one of two values through an Ising model-based support vector machine to classify first data; calculating an energy of a classification result of the first data for each of the plurality of classifiers; and determining a class of the first data based on the classification result in the classifying and the energy calculated in the calculating.

### Effects of the Invention

According to the present invention, it is possible to perform multi-value classification of data using an Ising model-based SVM.

### BRIEF DESCRIPTION OF DRAWINGS

FIG. 1 is a diagram illustrating an SVM.

FIG. 2 is a diagram illustrating an SVM.

FIG. 3 is a diagram illustrating a kernel trick.

FIG. 4 is a diagram illustrating a configuration example of a learning apparatus according to a first embodiment.

FIG. 5 is a diagram illustrating a configuration example of a classification apparatus according to the first embodiment.

FIG. 6 is a flowchart illustrating a flow of processing of the learning apparatus according to the first embodiment.

FIG. 7 is a flowchart illustrating a flow of processing of the classification apparatus according to the first embodiment.

FIG. 8 is a diagram illustrating a configuration example of a learning apparatus according to a second embodiment.

FIG. 9 is a diagram illustrating a configuration example of a classification apparatus according to a second embodiment.

FIG. 10 is a flowchart illustrating a flow of processing of the learning apparatus according to the second embodiment.

FIG. 11 is a flowchart illustrating a flow of processing of the classification apparatus according to the second embodiment.

FIG. 12 is a diagram illustrating an example of a computer that executes a classification program.

### DESCRIPTION OF EMBODIMENTS

Hereinafter, embodiments of a classification method, a classification apparatus, and a classification program according to the present application will be described in detail with reference to the drawings. The present invention is not limited to the embodiments described below.

Margin Maximization

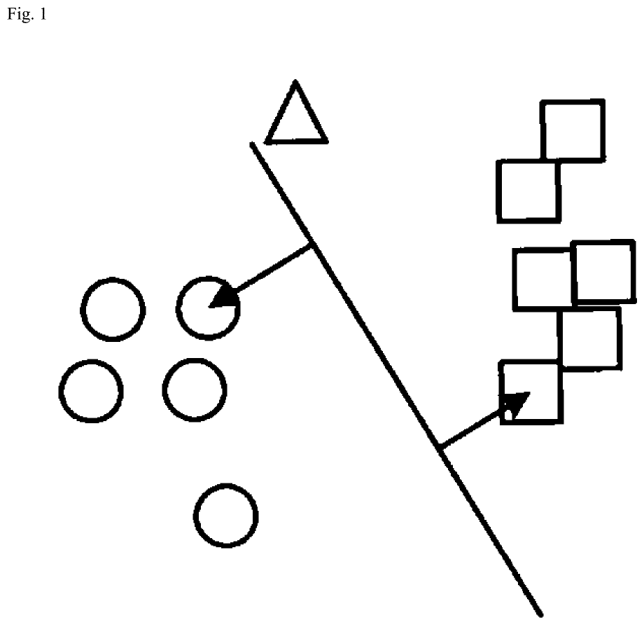

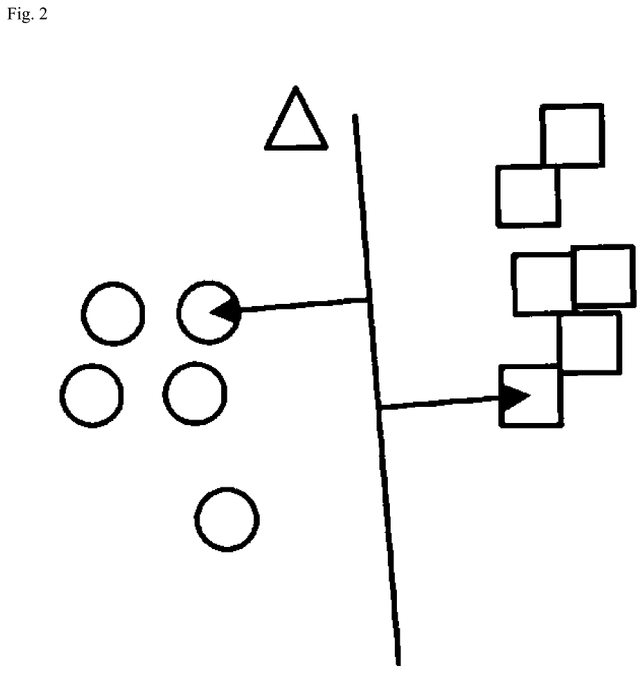

First, an SVM will be described. FIGS. 1 and 2 are diagrams illustrating an SVM. ∘ in FIG. 1 represents data known to belong to a first class. Further, □ represents data known to belong to a second class.

In the SVM, a boundary line for classifying data into the first class or the second class is drawn. When there is two-dimensional data xₙ belonging to one of two classes, a boundary line is expressed by a straight line such as y(x)=w^{T}x+w₀. w is a parameter of the SVM.

Further, in this case, a distance between data closest to the boundary line among data of each class and the boundary line is called a margin. In the SVM, a boundary line is drawn so that this margin is maximized.

FIG. 2 is a boundary line having a larger margin than the boundary line of FIG. 1. According to the SVM, it is possible to classify data of which a class to which the data belongs is unknown and which is indicated by Δ into the first class or the second class using a boundary line drawn so that the margin is maximized.

SVM Using d-Dimensional Data Kernel Trick

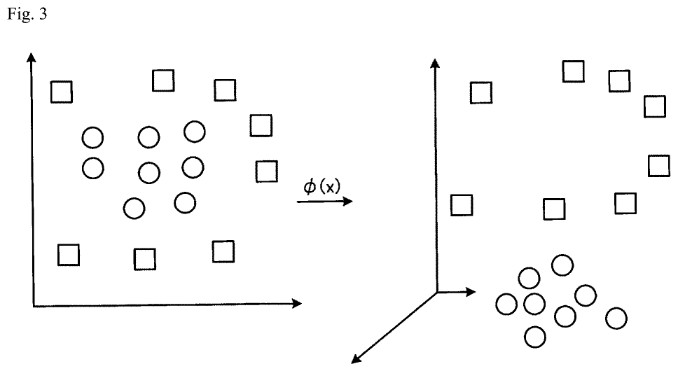

In the examples of FIGS. 1 and 2, a straight boundary line can be drawn. That is, in the examples of FIGS. 1 and 2, data is linearly separable. On the other hand, there is data that cannot be linearly separated, as illustrated on the left side of FIG. 3.

In such a case, kernel trick can be used to transform the data into a linearly separable state. For example, non-linear transformation based on a kernel φ(x) is performed so that data can be separated by a plane, as illustrated on the right side of FIG. 3.

Hereinafter, an SVM using kernel trick is referred to as a classic SVM (cSVM). Here, it is assumed that there is data D={(xₙ, tₙ): n=0, . . . , N−1}. xₙ∈R^{d} is a point on a d dimension. Further, to is a label corresponding to xₙ and takes 1 or −1. cSVM solves a quadratic programming problem shown in Equation (1).

$$[ Math . 1 ]$$

$${min}_{α} L ( {α}_{1} , … , {α}_{N} ) = \frac{1}{2} {\sum }_{n} {\sum }_{m} {α}_{n} {α}_{m} {t}_{n} {t}_{m} k ( {x}_{n} , {x}_{m} ) - {\sum }_{n} {α}_{n} \\ subject to 0 \leq {α}_{n} \leq C \\ and {\sum }_{n} {α}_{n} {t}_{n} = 0 \qquad ( 1 )$$

Here, α∈R, and C is a regularization parameter. Further, k(⋅,⋅) is a kernel function. There are a plurality of types of kernel functions, but it is assumed in the present embodiment that a Gaussian kernel rbf in Equation (2) is used as an example.

[Math. 2]

rbf(xₙ,xₘ)=e^{-γ∥x}^{ₙ}^{-x}^{ₘ}^{∥}^{²} (2)

Ising Model-Based SVM

An Ising model-based SVM will be described. Hereinafter, the Ising model-based SVM is referred to as a quantum SVM (qSVM). cSVM handles real number data, whereas the quantum annealing machine or the Ising machine, which are examples of an Ising model, can handle only discrete values. Further, when quadratic unconstrained binary optimization (QUBO; see NPL 2 for details) is used, qSVM can handle only bits qᵢ∈{0, 1}.

The learning apparatus and the classification apparatus of the present embodiment can realize qSVM using a method described in NPL 2. According to NPL 2, first, a real number an is encoded into discrete values as in Equation (3).

$$[ Math . 3 ]$$

$${α}_{n} = {\sum }_{k = 0}^{K - 1} {B}^{k} {a}_{Kn + k} \qquad ( 3 )$$

Here, a_{Kn+k} is a binary value. Further, K is the number of binary values for encoding an. Further, B is a base of encoding. For example, B may be set to 2 or 10.

From this, it can be said that qSVM solves a quadratic programming problem shown in Equation (4). E is a Hamiltonian energy in the Ising model. In learning of the Ising model, predetermined parameters are updated so that the energy E is minimized.

$$[ Math . 4 ]$$

$$E = \frac{1}{2} {\sum }_{n , m , k , j} {a}_{Kn + k} {a}_{Km + j} {B}^{k + j} {t}_{n} {t}_{m} k ( {x}_{n} , {x}_{m} ) - {\sum }_{n , k} {B}^{k} {a}_{Kn + k} + {ξ ( {\sum }_{n , k} {B}^{k} {a}_{Kn + k} {t}_{n} )}^{2} = {\sum }_{n , m = 0}^{N - 1} {\sum }_{k , j = 0}^{K - 1} {a}_{Kn + k} {\tilde{Q}}_{Kn + k , Km + j} {a}_{Km + j} \qquad ( 4 )$$

However, ˜Q (˜ immediately above Q) in Equation (4) is an upper triangular matrix having a KN×KN size. Thus, because the minimization of the energy E is a QUBO problem, it becomes possible to perform training of a model using a quantum annealing machine or an Ising machine.

### First Embodiment (One-VS-Rest (Pair and Others))

The learning apparatus of the first embodiment performs training of a plurality of classifiers using qSVM. Further, the classification apparatus of the first embodiment performs multi-class classification of data using a plurality of trained classifiers. The qSVM of the first embodiment classifies data into data belonging to one class and data belonging to another class.

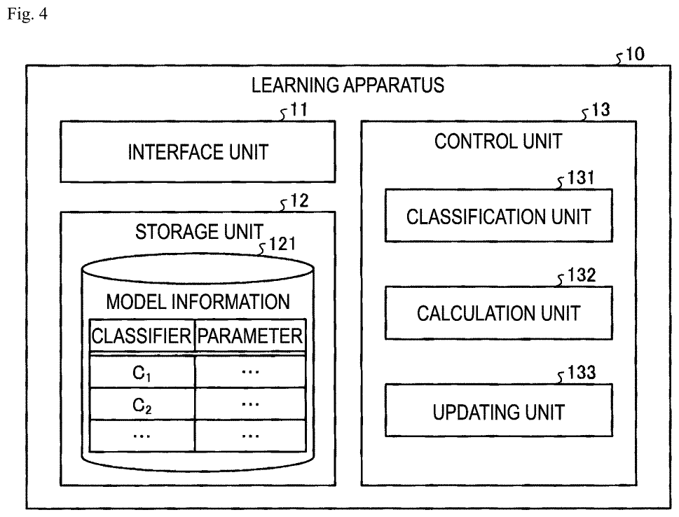

A configuration of the learning apparatus according to the first embodiment will be described with reference to FIG. 4. FIG. 4 is a diagram illustrating a configuration example of the learning apparatus according to the first embodiment. As illustrated in FIG. 4, the learning apparatus 10 includes an interface unit 11, a storage unit 12, and a control unit 13.

The interface unit 11 is an interface for input and output of data. The interface unit 11 receives an input of data via an input device such as a mouse or keyboard. Further, the interface unit 11 outputs, for example, data to an output device such as a display.

The storage unit 12 is a storage device such as a hard disk drive (HDD), a solid state drive (SSD), or an optical disc. The storage unit 12 may be a semiconductor memory in which data can be rewritten, such as a random access memory (RAM), a flash memory, or a non volatile static random access memory (NVSRAM). The storage unit 12 stores an operating system (OS) and various programs executed by the learning apparatus 10. The storage unit 12 stores model information 121.

The model information 121 is information on parameters of qSVM corresponding to a plurality of classifiers. In the first embodiment, each of the plurality of classifiers corresponds to a predetermined class. Here, it is assumed that each class is numbered. Further, a classifier associated with a class of which a number is n is indicated as a classifier Cₙ. Further, the nth class is indicated as class n.

The control unit 13 controls the entire learning apparatus 10. The control unit 13 is, for example, an electronic circuit such as a central processing unit (CPU) or a micro processing unit (MPU), or an integrated circuit such as an application specific integrated circuit (ASIC) or a field programmable gate array (FPGA). Further, the control unit 13 includes an internal memory for storing programs or control data that define various processing procedures, and executes each processing using the internal memory. Further, the control unit 13 functions as various processing units by various programs operating. For example, the control unit 13 includes a classification unit 131, a calculation unit 132, and an updating unit 133.

The classification unit 131 causes a plurality of classifiers to classify data for training. It is assumed that the data for training is data of which a class to which the data belongs, that is, a label of a correct answer is known. The classification unit 131 receives an input of the model information 121 and the data for training, and outputs a label of the classification result.

The calculation unit 132 calculates an energy of a classification result of the data for training for each of the plurality of classifiers. The calculation unit 132 can calculate the energy E using a method shown in Equation (4). The calculation unit 132 receives an input of the model information 121, the data for training, and the label output by the classification unit 131, and outputs an energy.

The updating unit 133 updates the model information 121 so that the energy calculated by the calculation unit 132 becomes smaller. The updating unit 133 receives an input of the energy calculated by the calculation unit 132, and outputs a parameter of each classifier after the updating. For example, the model information 121 is overwritten according to the value of the parameter output by the updating unit 133.

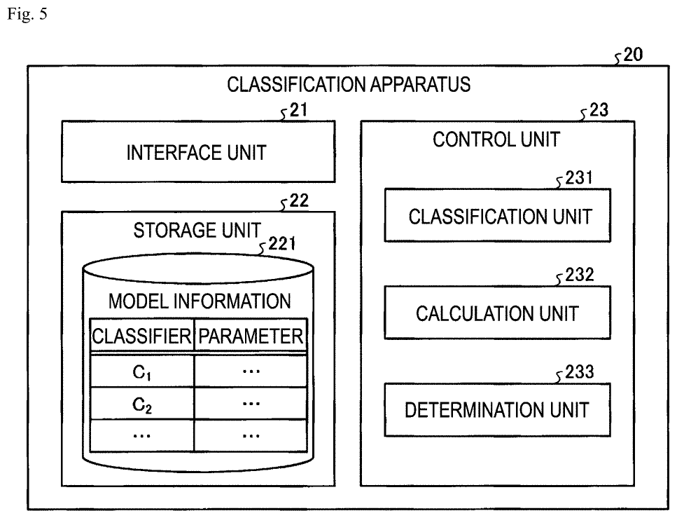

A configuration of the classification apparatus according to the first embodiment will be described with reference to FIG. 5. FIG. 5 is a diagram illustrating a configuration example of the classification apparatus according to the first embodiment. As illustrated in FIG. 5, the classification apparatus 20 includes an interface unit 21, a storage unit 22, and a control unit 23.

The interface unit 21 is an interface for input and output of data. The interface unit 21 receives an input of data via an input device such as a mouse or keyboard. Further, the interface unit 21 outputs data to an output device such as a display.

The storage unit 22 is a storage device such as an HDD, an SSD, or an optical disc. The storage unit 22 may be a semiconductor memory in which data can be rewritten, such as a RAM, a flash memory, or an NVSRAM. The storage unit 22 stores an OS or various programs executed by the classification apparatus 20. The storage unit 22 stores model information 221.

The model information 221 is a parameter of qSVM corresponding to a plurality of classifiers. It is assumed that the parameters of the model information 221 have been updated by the learning apparatus 10.

The control unit 23 controls the entire classification apparatus 20. The control unit 23 is, for example, an electronic circuit such as a CPU or MPU, or an integrated circuit such as an ASIC or FPGA. Further, the control unit 23 includes an internal memory for storing programs or control data that define various processing procedures, and executes each processing using the internal memory. Further, the control unit 23 functions as various processing units by various programs operating. For example, the control unit 23 includes a classification unit 231, a calculation unit 232, and a determination unit 233.

The classification unit 231 causes each of a plurality of classifiers trained to classify data of a corresponding class into one of two values through qSVM to classify data for training. The data for prediction is an example of the first data. For example, for the data for prediction, a class to which the data belongs, that is, a label of a correct answer may be unknown. The classification unit 231 receives an input of the model information 221 and the data for prediction, and outputs the label of the classification result.

The calculation unit 232 calculates an energy of the classification result of the data for prediction for each of the plurality of classifiers. The calculation unit 232 can calculate the energy E using the method shown in Equation (4). The calculation unit 232 receives an input of the model information 221, the data for prediction, and the label output by the classification unit 231 and outputs the energy.

The determination unit 233 determines the class of the data for prediction based on the classification result of the classification unit 231 and the energy calculated by the calculation unit 232.

Here, the classification result of the classification unit 231 is a set of labels output by the plurality of classifiers. Thus, the determination unit 233 identifies one label from the set of labels, and determines that the class corresponding to the classifier that outputs the identified label is the class of the data for prediction.

Further, when binary classification is performed using a trained SVM, it is not necessary to calculate the energy. The classification apparatus 20 of the first embodiment realizes multi-value classification by using both the label output by the classifier and the energy calculated from the classification results.

Here, it is assumed that the classifier Cₙ is trained to output a positive example (label t_{Cn}=1) when the classifier Cₙ classifies the data into the class n, and output a negative example (label t_{Cn}=−1) when the classifier Cn classifies the data into a class other than the class n. Here, N is a total number of classes, and n∈N.

In this case, when there is one classifier that classifies the data for prediction into a positive example among the classifiers, the determination unit 233 determines that the class corresponding to the classifier that classifies the data into a positive example is the class of the data for prediction. Further, when there are a plurality of classifiers that classify the data for prediction into a positive example among the classifiers, the determination unit 233 determines that the class corresponding to the classifier having the lowest energy among the classifiers that classify the data into a positive example is the class of the data for prediction. Further, when there is no classifier that classifies the data for prediction into a positive example among the classifiers, the determination unit 233 determines that the class corresponding to the classifier having the lowest energy is the class of the data for prediction.

A more specific example will be described. Here, it is assumed that N=3. That is, the classification unit 231 causes the classifier C₁, the classifier C₂, and the classifier C₃ to classify the data for prediction. Further, it is assumed that there are four data items for prediction including x₁, x₂, x₃, and x₄. Further, the energy of the classifier Cₙ calculated by the calculation unit 232 is indicated as E_{Cn}. For example, the calculation unit 232 calculates the energy E_{Cn} based on the label t_{Cn} that the classifier Cₙ has output for each of data x₁, x₂, x₃, and x₄.

It is assumed that the classification result of each classifier for the data x₁ is {C₁: 1, C₂: −1, C₃: −1}. In this case, because C₁ is the only classifier that classifies the data x₁ as a positive example, the determination unit 233 determines that the class of the data x₁ is class 1.

It is assumed that a classification result of each classifier for the data x₂ is {C₁: 1, C₂: 1, C₃: −1}. Further, it is assumed that E_{C1}>E_{C2}. In this case, because the classifiers that classify the data x₂ into a positive example are C₁ and C₂ and the energy of C₂ between both is lowest, the determination unit 233 determines that a class of the data x₂ is class 2.

It is assumed that a classification result of each classifier for the data x₃ is {C₁: −1, C₂: −1, C₃: −1}. Further, it is assumed that E_{C3}>E_{C1}>E_{C2}. In this case, there is no classifier that classifies the data x₃ as a positive example, but because the energy of C₂ is lowest, the determination unit 233 determines that a class of the data x₃ is class 2.

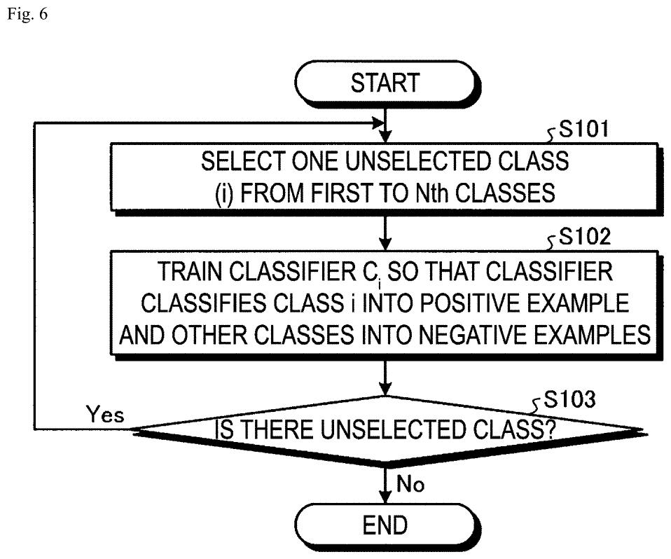

A flow of the learning processing of the first embodiment will be described with reference to FIG. 6. FIG. 6 is a flowchart illustrating a flow of processing of the learning apparatus according to the first embodiment. As illustrated in FIG. 6, first, the learning apparatus 10 selects an unselected class (i) from first to Nth classes (step S101).

The learning apparatus 10 trains the classifier Cᵢ so that the classifier classifies the class i as a positive example and the other classes as a negative example (step S102). When there is an unselected class (step S103: Yes), the learning apparatus 10 repeats processing of returning to step S101. On the other hand, when there is no unselected class (step S103: No), the learning apparatus 10 ends the processing.

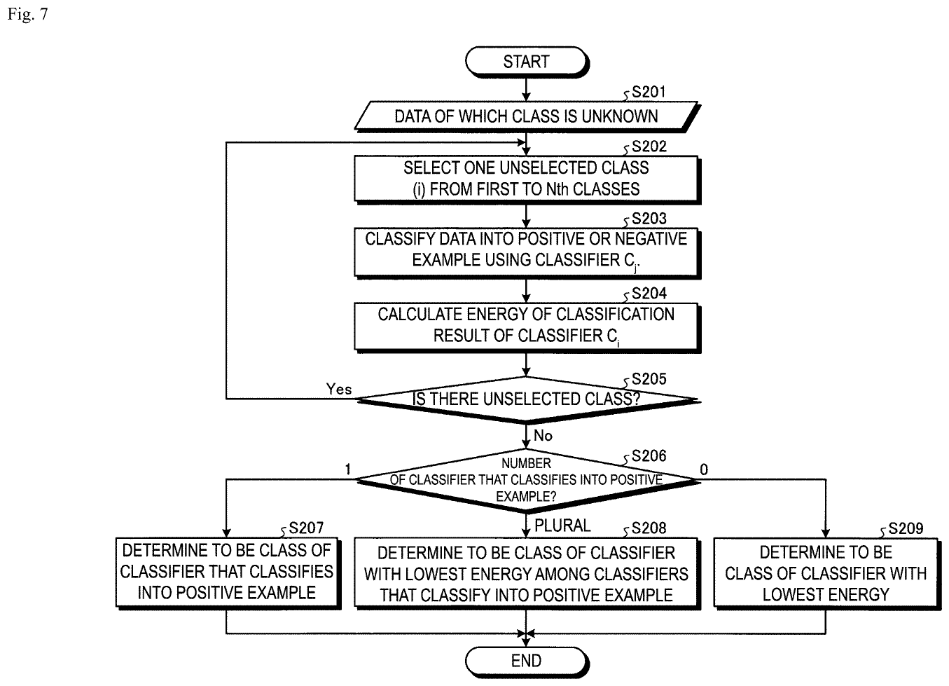

A flow of the classification processing of the first embodiment will be described with reference to FIG. 7. FIG. 7 is a flowchart illustrating a flow of processing of the classification apparatus according to the first embodiment. As illustrated in FIG. 7, data of which a class is unknown is input to the classification apparatus 20 (step S201).

First, the classification apparatus 20 selects an unselected class (i) from the first to Nth classes (step S202). The classification apparatus 20 classifies the data into a positive or negative example using the classifier Cᵢ (step S203). The classification apparatus 20 calculates an energy of a classification result of the classifier Cᵢ (step S204).

When there is an unselected class (step S205: Yes), the classification apparatus 20 repeats processing of returning to step S202. On the other hand, when there is no unselected class (step S205: No), the classification apparatus 20 proceeds to step S206.

When the number of classifiers that classify the data into the positive example is 1 (step S206: 1), the classification apparatus 20 determines that the class of the classifier that classifies the data into the positive example is a class of the data (step S207). When the number of classifiers that classify the data into the positive example is plural (step S206: plural), the classification apparatus 20 determines that the class of the classifier having the lowest energy among the classifiers that classify the data into the positive example is the class of the data (step S208). When the number of classifiers that classify the data into the positive example is 0 (steps S206: 0), the classification apparatus 20 determines that the class of the classifier having the lowest energy is the class of the data (step S209).

As described above, the classification unit 231 causes each of a plurality of classifiers trained to classify data of a corresponding class into one of two values through qSVM to classify the data for prediction. Further, the calculation unit 232 calculates the energy of the classification result of the data for prediction for each of the plurality of classifiers. Further, the determination unit 233 determines the class of the data for prediction based on the classification result of the classification unit 231 and the energy calculated by the calculation unit 232. Thus, the classification apparatus 20 can use qSVM, which is originally a scheme for binary classification, to perform multi-value classification of data.

The classification unit 231 causes a plurality of classifiers, each of the plurality of classifiers corresponding to one of a plurality of classes and trained to classify data of the corresponding class into a positive example and classify classes other than the corresponding class into negative examples to classify the data for prediction. Further, the determination unit 233 determines that the class corresponding to the classifier that classifies the data into the positive example is the class of the data for prediction when there is one classifier that classifies the data for prediction into a positive example among the classifiers, determines that the class corresponding to the classifier having the lowest energy among the classifiers that classify the data into the positive example is the class of the data for prediction when there are a plurality of classifiers that classify the data for prediction into the positive example among the classifiers, and determines that the class corresponding to the classifier having the lowest energy is the class of the data for prediction when there is no classifier that classifies the data for prediction into the positive example among the classifiers. Thus, the classification apparatus 20 can determine one class by calculating the energy even when classification results of the plurality of classifiers do not match and the class is not determined to be one.

### Second Embodiment (One-VS-One)

In the first embodiment, one class are associated with each of classifiers. On the other hand, in the second embodiment, two classes are associated with each of classifiers. For example, a classifier to which class m and class n are associated is indicated as C_{m,n}. In the description of the second embodiment, description of the processing unit having the same names as those of the first embodiment will be omitted appropriately, and differences from the first embodiment will be mainly described.

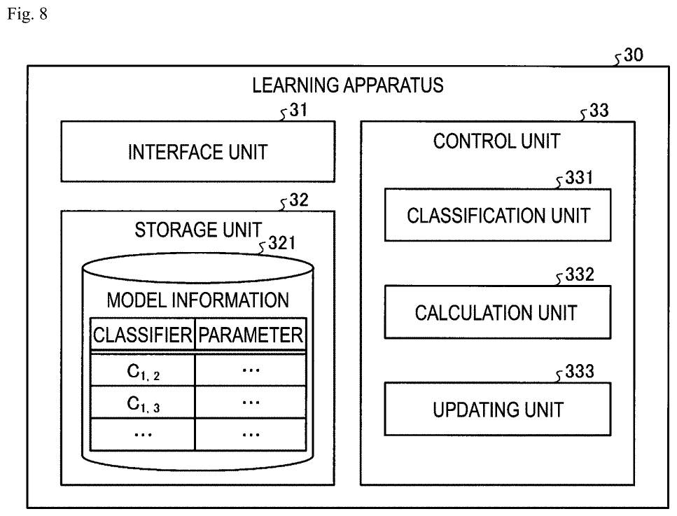

A configuration of the learning apparatus according to the second embodiment will be described with reference to FIG. 8. FIG. 8 is a diagram illustrating a configuration example of the learning apparatus according to the second embodiment. As illustrated in FIG. 8, the learning apparatus 30 includes an interface unit 31, a storage unit 32, and a control unit 33.

While the model information 121 of the learning apparatus 10 of the first embodiment is a parameter of the classifier with which one class is associated, model information 321 stored in the storage unit 32 is information on parameters of classifiers with which two classes are associated, such as C_{1, 2} and C_{2, 3}.

The control unit 33 includes a classification unit 331, a calculation unit 332, and an updating unit 333. The classification unit 331 causes a plurality of classifiers to classify the data for training, like the classification unit 131 of the first embodiment. Here, in the second embodiment, a meaning of the label output by the classifier is different from that in the first embodiment. For example, in the first embodiment, the classifier Cn outputs the label meaning class n and the label meaning another class. On the other hand, for example, in the second embodiment, the classifiers Cm, n outputs a label meaning class n and a label meaning class m.

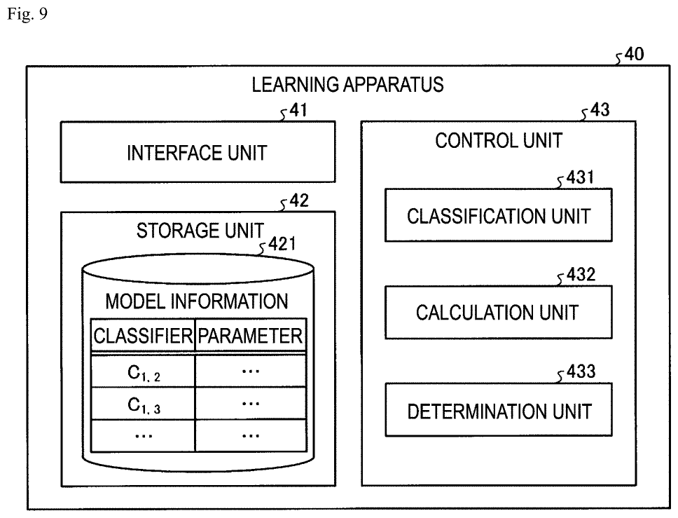

A configuration of the classification apparatus according to the second embodiment will be described with reference to FIG. 9. FIG. 9 is a diagram illustrating a configuration example of the classification apparatus according to the second embodiment. As illustrated in FIG. 9, a classification apparatus 40 includes an interface unit 41, a storage unit 42, and a control unit 43.

Model information 421 is information on parameters of qSVM corresponding to a plurality of classifiers. It is assumed that the parameters of the model information 421 have been updated by the learning apparatus 30.

The control unit 43 controls the entire classification apparatus 40. The control unit 43 is, for example, an electronic circuit such as a CPU or MPU, or an integrated circuit such as an ASIC or FPGA. Further, the control unit 43 includes an internal memory for storing programs or control data that define various processing procedures, and executes each processing using the internal memory. Further, the control unit 43 functions as various processing units by various programs operating. For example, the control unit 43 includes a classification unit 431, a calculation unit 432, and a determination unit 433.

The classification unit 431 causes a plurality of classifiers, each of the plurality of classifiers corresponding to two of a plurality of classes and trained to classify the data into one of the corresponding classes, to classify the data for prediction.

When there is one class having the largest number of times of classification in the classifier among the plurality of classes, the determination unit 433 determines that the one class is the class of the data for prediction. Further, when there are a plurality of classes having the number largest number of times of classification in the classifier among the plurality of classes, the determination unit 433 determines that the class in which an average energy of the classifying classifier is lowest is the class of the data for prediction.

Here, it is assumed that the classifier C_{m,n} is trained to output a positive example (label t_{Cm,n}=1) when the classifier classifies the data into the class m, and output a negative example (label t_{Cm,n}=−1) when the classifier classifies the data into the class n. Here, N is a total number of classes, and m, n∈N. When two classes associated with the classifier is selected, the same class and duplication of classes are not allowed. Thus, the number of classifiers is N(N−1)/2.

In this case, when there is one classifier that classifies the data for prediction into a positive example among the classifiers, the determination unit 433 determines that the class corresponding to the classifier that classifies the data into the positive example is the class of the data for prediction. Further, when there are a plurality of classifiers that classify the data for prediction into the positive example among the classifiers, the determination unit 433 determines that the class corresponding to the classifier having the lowest energy among the classifiers that classify the data into the positive example is the class of the data for prediction. Further, when there is no classifier that classifies the data for prediction into the positive example among the classifiers, the determination unit 433 determines that the class corresponding to the classifier having the lowest energy is the class of the data for prediction.

A more specific example will be described. Here, N=4. That is, the classification unit 431 causes a classifier C_{1,2}, a classifier C_{1,3}, a classifier C_{1,4}, a classifiers C_{2,3}, a classifiers C_{2,4}, and a classifier C_{3,4} to classify the data for prediction. Further, it is assumed that the data for prediction is x₁. Further, an energy of the classifier C_{m,n} calculated by the calculation unit 432 is indicated as E_{Cm,n}. For example, the calculation unit 432 calculates the energy E_{Cm,n} based on the label t_{Cm,n} that the classifiers C_{m,n} has output for the data x₁.

It is assumed that the classification result of each classifier for the data x₁ was {C_{1, 2}: 2, C_{1, 3}: 1, C_{1, 4}: 1, C_{2, 3}: 2, C_{2, 4}: 4, C_{3, 4}: 3}. This means, for example, that the classifier C_{1,2} classifies the data x₁ into class 1, the classifier C_{1,2} classifies the data x₁ into class 1, and the classifier C_{2,4} classifies the data x₁ into class 4. Further, it is assumed that E_{C1, 2}=−303, E_{C1, 3}=−323, E_{C1, 4}=−322, E_{C2, 3}=−311, E_{C2, 4}=−311, and EC_{3, 4}=−310.

From this, the number of classifiers that classify the data into class 1 and the number of classifiers that classify the data into class 2 are both 2, which is largest. Here, an energy of the classifier that classifies data into a certain class may be an average of the energies of a plurality of classifiers. Thus, because the classifiers that classify the data into class 1 are C_{1, 3} and C_{1, 4}, the energy of the classifiers that classify the data into class 1 is (E_{C1, 3}+E_{C1, 4})/2=−322.5. Further, because the classifiers that classify the data into class 2 are C_{1, 2} and C_{2, 3}, the energy of the classifiers that classify the data into class 2 is (E_{C1, 2}+E_{C2, 3})/2=−307. As a result, because the energy of the classifier that classifies the data into class 1 is lowest, the determination unit 433 determines that a class of data x₁ is class 1.

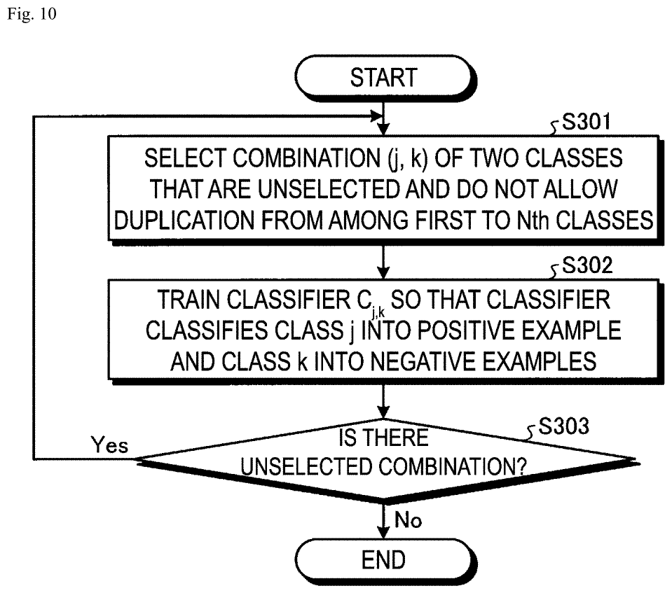

A flow of learning processing of the second embodiment will be described with reference to FIG. 10. FIG. 10 is a flowchart illustrating a flow of processing of the learning apparatus according to the second embodiment. As illustrated in FIG. 10, first, the learning apparatus 30 selects a combination (j, k) of two classes that are not selected and do not allow duplication from among the first to Nth classes (step S301).

The learning apparatus 30 trains a classifier C_{j,k} so that the classifier Cj,k classifies a class j into a positive example and a class k into a negative example (step S302). When there is an unselected combination (step S303: Yes), the learning apparatus 30 repeats processing of returning to step S301. On the other hand, when there is no unselected class (step S303: No), the learning apparatus 30 ends the processing.

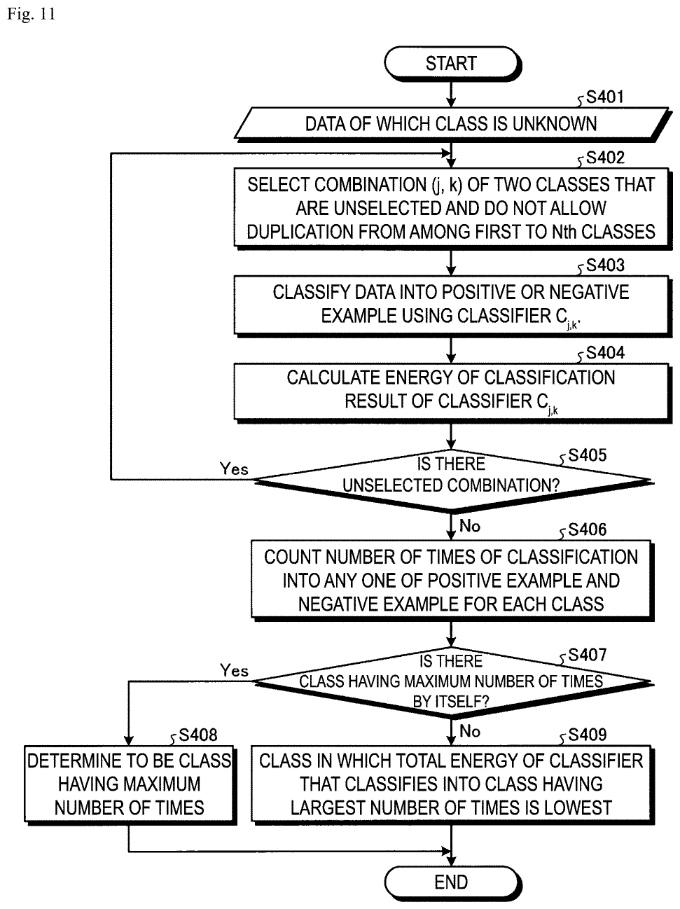

A flow of the classification processing of the second embodiment will be described with reference to FIG. 11. FIG. 11 is a flowchart illustrating a flow of processing of the classification apparatus according to the second embodiment. As illustrated in FIG. 11, data of which a class is unknown is input to the classification apparatus 40 (step S401).

First, the classification apparatus 40 selects the combination (j, k) of two classes that are not selected and do not allow duplication from among the first to Nth classes (step S402). The classification apparatus 40 classifies the data into a positive or negative example through the classifier C_{j,k} (step S403). The classification apparatus 40 calculates an energy of a classification result of the classifier Cj,k (step S404).

When there is an unselected combination, the classification apparatus 40 repeats processing of returning to step S402 (step S405). When there is no unselected combination, the classification apparatus 40 proceeds to step S406.

The classification apparatus 40 counts the number of times of classification into any one of a positive example and a negative example for each class (step S406). When there is a class having the largest number of times by itself (step S407: Yes), the classification apparatus 40 determines that the class having the largest number of times is the class of the data (step S408). When there is no class having the largest number of times by itself (step S407: No), the classification apparatus 40 determines that a class in which a total energy of the classifiers that classify the data into the class having the largest number of times is lowest is the class of the data (step S409).

As described above, the classification unit 431 causes a plurality of classifiers, each of the plurality of classifiers corresponding to two of a plurality of classes and trained to classify the data into one of the corresponding classes, to classify the data for prediction. Further, the determination unit 433 determines that the one class is the class of the data for prediction when there is one class having the largest number of times of classification in the classifier among the plurality of classes, and determines that the class in which an average energy of the classifying classifier is lowest is the class of the data for prediction when there are a plurality of classes having the number largest number of times of classification in the classifier among the plurality of classes. Thus, the classification apparatus 40 can determine one class by calculating the energy even when classification results of the plurality of classifiers do not match and the class is not determined to be one.

System Configuration or the Like

Further, each component of each illustrated apparatus is a functional conceptual component and does not necessarily need to be physically configured as illustrated in the drawings. That is, a specific form of distribution and integration of the respective apparatuses is not limited to the form illustrated in the drawings, and all or some of the devices can be distributed or integrated functionally or physically in any units according to various loads, and use situations. Further, all or some of processing functions to be performed in each of the apparatuses can be realized by a CPU and a program analyzed and executed by the CPU, or can be realized as hardware using a wired logic.

Further, all or some of the processing described as being performed automatically among the processing described in the present embodiment can be performed manually, and alternatively, all or some of the processing described as being performed manually can be performed automatically using a known method. In addition, information including the processing procedures, control procedures, specific names, and various types of data or parameters illustrated in the above literature or drawings can be arbitrarily changed unless otherwise described.

Program

As an embodiment, the classification apparatus 20 can be implemented by installing a classification program for executing the classification processing in a desired computer as packaged software or on-line software.

For example, it is possible to cause an information processing apparatus to function as the classification apparatus 20 by causing the information processing apparatus to execute the classification program. Here, the information processing apparatus includes a desktop or laptop personal computer. Further, a mobile communication terminal such as a smart phone, a mobile phone, or a personal handyphone system (PHS), or a slate terminal such as a personal digital assistant (PDA), for example, is included in a category of the information processing apparatus.

Further, the classification apparatus 20 can be implemented as a classification server apparatus that provides a service regarding the above classification processing to a client, which is a terminal apparatus used by a user. For example, the classification server apparatus is implemented as a server device that provides a classification service that receives data of which the class is unknown as an input and outputs the label of the classification result. In this case, the classification server apparatus may be implemented as a web server, or may be implemented as a cloud that provides a service regarding the above classification processing through outsourcing.

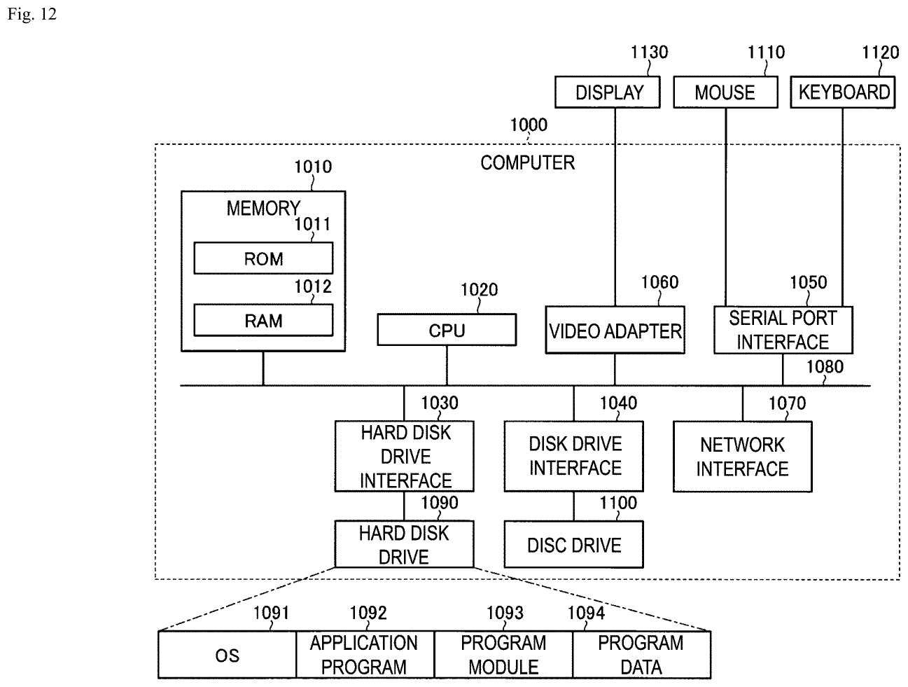

FIG. 12 is a diagram illustrating an example of a computer that executes a classification program. A computer 1000 includes, for example, a memory 1010 and a CPU 1020. The computer 1000 also includes a hard disk drive interface 1030, a disc drive interface 1040, a serial port interface 1050, a video adapter 1060, and a network interface 1070. Each of these units is connected by a bus 1080.

The memory 1010 includes a read only memory (ROM) 1011 and a RAM 1012. The ROM 1011 stores, for example, a boot program such as a basic input output system (BIOS). The hard disk drive interface 1030 is connected to a hard disk drive 1090. The disc drive interface 1040 is connected to a disc drive 1100. For example, a removable storage medium such as a magnetic disk or an optical disc is inserted into the disc drive 1100. The serial port interface 1050 is connected to, for example, a mouse 1110 and a keyboard 1120. The video adapter 1060 is connected to, for example, a display 1130.

The hard disk drive 1090 stores, for example, an OS 1091, an application program 1092, a program module 1093, and a program data 1094. That is, a program that defines each processing of the classification apparatus 20 is implemented as the program module 1093 in which a code that can be executed by a computer is described. The program module 1093 is stored in, for example, the hard disk drive 1090. For example, the program module 1093 for executing the same processing as that of a functional configuration in the classification apparatus 20 is stored in the hard disk drive 1090. The hard disk drive 1090 may be replaced with an SSD.

Further, configuration data to be used in the processing of the embodiment described above is stored as the program data 1094 in, for example, the memory 1010 or the hard disk drive 1090. The CPU 1020 reads the program module 1093 or the program data 1094 stored in the memory 1010 or the hard disk drive 1090 into the RAM 1012 as necessary, and executes the processing of the embodiment described above.

The program module 1093 or the program data 1094 is not limited to being stored in the hard disk drive 1090, and may be stored, for example, in a detachable storage medium and read by the CPU 1020 via the disc drive 1100 or the like. Alternatively, the program module 1093 and the program data 1094 may be stored in another computer connected via a network (a local area network (LAN), a wide area network (WAN), or the like). The program module 1093 and the program data 1094 may be read from another computer via the network interface 1070 by the CPU 1020.

### REFERENCE SIGNS LIST

10, 30 Learning apparatus
20, 40 Classification apparatus
11, 21, 31, 41 Interface unit
12, 22, 32, 42 Storage unit
13, 23, 33, 43 Control unit
121, 221, 321, 421 Model information
131, 231, 331, 431 Classification unit
132, 232, 332, 432 Calculation unit
133, 333 Updating unit
233, 433 Determination unit

1. A classification method, comprising:
causing each of a plurality of classifiers trained to classify data of a corresponding class into one of two values through an Ising model-based support vector machine to classify first data;
calculating an energy of a classification result of the first data for each of the plurality of classifiers; and
determining a class of the first data based on the classification result in the classifying and the energy calculated in the calculating.

2. The classification method according to claim 1,
wherein the classifying includes causing a plurality of classifiers, each of the plurality of classifiers corresponding to one of a plurality of classes and trained to classify data of the corresponding class into a positive example and classify classes other than the corresponding class into negative examples to classify the first data, and
the determining includes: determining that the class corresponding to the classifier that classifies the data into the positive example is a class of the first data when there is one classifier that classifies the first data into a positive example among the classifiers,
determining that the class corresponding to the classifier having a lowest energy among the classifiers that classify the data into the positive example is the class of the first data when there are a plurality of classifiers that classify the first data into the positive example among the classifiers, and
determining that the class corresponding to the classifier having the lowest energy is the class of the first data when there is no classifier that classifies the first data into the positive example among the classifiers.

3. The classification method according to claim 1,
wherein the classifying includes causing a plurality of classifiers, each of the plurality of classifiers corresponding to two of a plurality of classes and trained to classify the data into one of the corresponding classes, to classify first data, and
the determining includes determining the one class to be a class of the first data when there is one class having the largest number of times of classification in the classifier among the plurality of classes, and
determining a class having a lowest average energy of the classifying classifier to be a class of the first data when there are a plurality of classes having the largest number of times of classification in the classifier among the plurality of classes.

4. A classification apparatus, comprising:
classification circuitry configured to cause each of a plurality of classifiers trained to classify data of a corresponding class into one of two values through an Ising model-based support vector machine to classify first data;
calculation circuitry configured to calculate an energy of a classification result of the first data for each of the plurality of classifiers; and
determination circuitry configured to determine a class of the first data based on the classification result of the classification circuitry and the energy calculated in the calculation circuitry.

5. A non-transitory computer readable medium including a classification program which when executed causes a computer to perform the method of claim 1.
